(19) United States
(12) Patent Application Publication
(10) Pub. No.: US 2015/0053491 A1
(43) Pub. Date: Feb. 26, 2015

(54) Thermal management system for fuel cell, fuel cell system and vehicle equipped with fuel cell system

(71) Applicants: Hao Tang, Chengdu (CN); Jiao Lei, Chengdu (CN); Zhankui Zhang, Chengdu (CN); Haiyu Yang, Chengdu (CN); Yun Li, Chengdu (CN)

(72) Inventors: Hao Tang, Chengdu (CN); Jiao Lei, Chengdu (CN); Zhankui Zhang, Chengdu (CN); Haiyu Yang, Chengdu (CN); Yun Li, Chengdu (CN)

(73) Assignee: DONGFANG ELECTRIC CORPORATION, Chengdu, SC (CN)

(21) Appl. No.: 14/386,887

(22) PCT Filed: Jul. 26, 2012
(86) PCT No.: PCT/CN2012/079217

§ 371 Date: Sep. 22, 2014

(30) Foreign Application Priority Data
Mar. 22, 2012 (CN) 201210078815.2

(51) Int. Cl. H01M 8/04; B60L 11/18

(52) U.S. Cl. CPC H01M 8/04037; H01M 8/04029; B60L 11/1892; B60L 11/1894; H01M 2250/20
USPC 180/65.31; 429/440; 429/437; 429/435

(57) ABSTRACT

The invention provides a thermal management system for a fuel cell, a fuel cell system and a vehicle equipped with the fuel cell system. The thermal management system for a fuel cell comprises: a cooling system (100) for recovering the waste heat produced by the fuel cell system, a heat supply system (15) connected with the cooling system (100) to supply heat using the waste heat recovered by the cooling system (100). The fuel cell system comprises a fuel cell stack and the aforementioned thermal management system for a fuel cell. The vehicle comprises the fuel cell system, wherein the thermal management system for a fuel cell reduces the temperature of each component of the fuel cell system by cooling the component using the cooling system (100) and recovers the waste heat generated by the fuel cell system, and the heat supply system (15) supplies heat by using the waste heat recovered by the cooling system as a heat source, thus effectively using the heat generated by a fuel cell stack, the heat of exhaust gas and the heat generated by electrical accessories during the running process of the fuel cell stack and consequentially reducing the running cost of the fuel cell.

### TECHNICAL FIELD OF THE INVENTION

The invention relates to the field of the heat dissipation of a fuel cell for vehicles, and more particularly to a thermal management system for a fuel cell, a fuel cell system and a vehicle equipped with the fuel cell system.

### BACKGROUND OF THE INVENTION

With a range of outstanding performances such as high efficiency, zero emission, stable running and no noise, a fuel cell vehicle driven by the power resulting from the electrochemical reaction of a fuel cell is called ‘authentic environment-friendly vehicle’ and is the trend of the development of the vehicle industry in the future. The core component of a fuel cell vehicle lies in a fuel cell stack. Fuel cell is a clean, efficient and sustainable power generator. Take Proton Exchange Membrane Fuel Cell (PEMFC) for example, a fuel gas (hydrogen or reformed hydrogen) enters the cell from the anode side of the cell, hydrogen atoms lose electrons at the anode and then turn into protons which pass through a proton exchange film to reach a cathode, simultaneously, electrons reach the cathode via an external loop, then the protons, the electrons and oxygen combine with each other at the cathode to generate water. By converting chemical energy into electric energy through an electrochemical reaction, fuel cell is free from the limitation of Carnot cycle and achieves a direct power generation efficiency up to 45% and therefore has been widely used in power station, mobile power supply, electric vehicle, spaceship, military equipment, civil products and other fields.

A working fuel cell stack generates a great amount of heat, which accounts for 50% of the chemical energy of the fuel, take a fuel cell stack the output of which is 100 kW as example, the fuel cell stack generates about 100 kW heat which leads to a rise in the temperature of the fuel cell stack, the over-high temperature dries a film, undermines the performance of the film and shortens the service life of the film, which consequentially degrades the performance of the fuel cell stack and shortens the service life of the fuel cell stack, meanwhile, electrical devices of the fuel cell, comprising a power management system, generate plenty of heat as well. To improve the working efficiency and prolong the service life of a fuel cell and relevant electrical devices, it is needed to remove the heat generated by a fuel cell system and related components (e.g. power management system, reactant gas and cooling liquid supply pumps) timely.

An integrated vehicle cooling system which realizes the integration of an internal combustion engine with an auxiliary component cooling system through device sharing has been proposed in the patent application ‘integrated vehicle cooling system’ (Patent Application No. 200810131536.1) invented by GM Global Technology Operations, Inc.

A vehicle-mounted cooling circulatory system for urban fuel cell bus which cools vehicle-mounted electrical devices to enable electric appliances of an urban fuel cell bus to work safely in a controllable temperature range has been proposed in the patent application ‘vehicle-mounted cooling circulatory system for urban fuel cell bus’ (Patent Application No. 200810246572.2) invented by Tsinghua University.

A cooling system for a fuel cell vehicle has been proposed in the patent application ‘cooling system for fuel cell vehicle’ (Patent Application No. 201010266526.6) invented by Hyundai Motor Company, which comprises an integrated radiator frame on which stacked radiators and the radiator of an electric transmission system are connected in series on a plane, and which can be realized with a relatively simple structure through a simple assembly process.

A heat pump air-conditioning system utilizing the waste heat of a fuel cell motor has been proposed in the patent application ‘heat pump air-conditioning system for fuel cell vehicle’ (Patent Application No. 200810113785.8) invented by Tsinghua University, which is capable of meeting requirements on cooling and heating at the same time and therefore reduces the energy consumption of an air-conditioning system and improves the dynamic property and the economical efficiency of a vehicle.

Technical researches that have been made reveal that the current research on fuel cells for vehicle mainly focuses on how to effectively cool a fuel cell stack the effective cooling, forms no efficient integrated thermal management optimization system and fails to effectively utilize the heat generated by a fuel cell stack, the heat of exhaust gas and the heat generated by electrical accessories during the running process of the fuel cell stack, which will increase the running cost of the fuel cell and slow the process of the industrialization of fuel cell vehicle.

### SUMMARY OF THE INVENTION

The purpose of the invention is to provide a thermal management system for a fuel cell for comprehensively utilizing the heat generated by the fuel cell, a fuel cell system and a vehicle equipped with the fuel cell system to address the problem that the waste heat of a fuel cell system cannot be used effectively.

The thermal management system for a fuel cell disclosed herein comprises: a cooling system to recover the waste heat generated by a fuel cell system, and a heat supply system connected with the cooling system to supply heat using the waste heat recovered by the cooling system.

Further, the heat supply system comprises: a waste heat supply system configured to supply heat using the waste heat recovered by the cooling system; and an electric heating heat supply system configured to electrically supply heat.

Further, the waste heat supply system comprises: a cooling liquid heat supply system provided at the downstream of the cooling system along the flow direction of a cooling medium; and an exhaust gas heat supply system connected with the exhaust gas outlet of a fuel cell stack.

Further, the cooling liquid heat supply system comprises: cooling liquid heaters provided at the downstream of the cooling system along the flow direction of the cooling medium and fans provided corresponding to the cooling liquid heaters.

Further, there are a plurality of cooling liquid heaters which are connected with each other in series or in parallel or in series and in parallel and provided at the downstream of the cooling system along the flow direction of the cooling medium, and one or more fans are correspondingly provided for each cooling liquid heater.

Further, the electric heating system is connected with the waste heat supply system in parallel.

Further, the cooling system comprises a fuel cell stack cooling system and an electrical device cooling system which are interconnected with each other through a pipeline, wherein the electrical device cooling system comprises a pump cooling system and a power supply management system cooling system; and the power supply management system cooling system is provided at the upstream or downstream of the fuel cell stack cooling system along the flow direction of the cooling medium.

Further, the power supply management system cooling system is an external cooling system or an internal cooling system; the cooling pipeline of the external cooling system is located outside of a power supply management system and attached to the power supply management system; and the cooling pipeline of the internal cooling system is located inside the power supply management system.

Further, the thermal management system for a fuel cell also comprises a heat radiation system which comprises: a plurality of radiators which are connected with each other in series or in parallel or in series and in parallel and provided at the downstream of the heat supply system along the flow direction of the cooling medium; and cooling fans, wherein one or more cooling fans are correspondingly provided for each radiator.

Further, the thermal management system for a fuel cell also comprises a control system which comprises: a cooling system control system comprising, the cooling system control system: a cooling medium container temperature control system for starting a heater to heat the cooling medium when the temperature of the cooling medium is lower than a first preset value, a pump temperature control system for starting a pump cooling system to reduce the temperature of a liquid pump and a gas pump when the temperature of the liquid pump and the temperature of the gas pump are higher than a second preset value, a power supply management system temperature control system for starting a power supply management system cooling system to reduce the temperature of the power supply management system when the temperature of the power supply management system is higher than a third preset value, and a pump flow control system for increasing the flow of the liquid pump to reduce the temperature of the fuel cell stack when the temperature of the fuel cell stack is higher than a fourth preset value.

Further, the control system also comprises a heat supply system control system for starting the heat supply system to supply heat when indoor temperature is lower than a preset heating temperature.

Further, The heat supply system control system comprises: a cooling liquid heat supply system control system which controls the cooling liquid heaters of the cooling liquid heat supply system to starts, one by one, to supply heat and starts fans corresponding to the cooling liquid heater when indoor temperature is lower than the preset heating temperature; an exhaust gas heat supply system control system which controls the exhaust gas heat supply system to start to supply heat together with the cooling liquid heat supply system when the maximum heating temperature of the cooling liquid heat supply system is lower than the preset heating temperature; and an electric heating heat supply system control system which controls starts the electric heating system to start to supply heat together with the exhaust gas heat supply system and the cooling liquid heat supply system when the maximum heating temperature offered by the exhaust gas heat supply system and the cooling liquid heat supply system working together is lower than the preset heating temperature.

Further, the control system also comprises a heat radiation system control system for starting the heat radiation system to cool the cooling medium when the temperature of the cooling medium inside the pipeline between the heat radiation system and the heat supply system is higher than a fifth preset value.

The invention also provides a fuel cell system which comprises a fuel cell stack and the aforementioned thermal management system for a fuel cell.

The invention also provides a vehicle which comprises wheels, a vehicle body and a transmission system, wherein the vehicle is a car equipped with the foregoing fuel cell system; the thermal management system for a fuel cell of the fuel cell system comprises a power supply management system cooling system and a fuel cell stack cooling system, wherein the power supply management system cooling system is provided at the upstream of the fuel cell stack cooling system along the flow direction of a cooling medium, and the power supply management system cooling system is an external cooling system; and the heat supply system of the thermal management system for a fuel cell supplies heat to the inside of the body of the car.

The invention also provides a vehicle which comprises wheels, a vehicle body and a transmission system, wherein the vehicle is a bus equipped with the foregoing fuel cell system; the thermal management system for a fuel cell of the fuel cell system comprises a power supply management system cooling system and a fuel cell stack cooling system, wherein the power supply management system cooling system is provided at the upstream of the fuel cell stack cooling system along the flow direction of a cooling medium, the power supply management system cooling system is an internal or external cooling system; and the heat supply system of the thermal management system for a fuel cell supplies heat to the inside of the body of the bus.

The invention also provides a vehicle which comprises wheels, a vehicle body and a transmission system, wherein the vehicle is a large locomotive equipped with the foregoing fuel cell system; the thermal management system for a fuel cell of the fuel cell system comprises a power supply management system cooling system and a fuel cell stack cooling system, wherein the power supply management system cooling system is provided at the downstream of the fuel cell stack cooling system along the flow direction of a cooling medium, the power supply management system cooling system is an internal or external cooling system; and the heat supply system of the thermal management system for a fuel cell supplies heat to the inside of the body of the large locomotive.

According to the thermal management system for a fuel cell and the fuel cell system provided with the same disclosed herein, the thermal management system for a fuel cell reduces the temperature of each component of the fuel cell system by cooling the component using a cooling system and recovers the waste heat generated by the fuel cell system, and a heat supply system supplies heat by using the waste heat recovered by the cooling system as a heat source, thus effectively using the heat generated by a fuel cell stack, the heat of exhaust gas and the heat generated by electrical accessories during the running process of the fuel cell stack and consequentially reducing the running cost of the fuel cell.

### BRIEF DESCRIPTION OF THE DRAWINGS

The accompanying drawings described herein are provided for a better understanding of the invention and form one part of the invention, and the exemplary embodiments of the invention and the description thereof are illustrative of the invention but are not to be construed as limiting the invention. In the accompanying drawings:

FIG. 1 is a schematic diagram illustrating the structural frame of the thermal management system for a fuel cell disclosed herein;

FIG. 2 is a block diagram illustrating the structure of a thermal management system for a fuel cell according to a first embodiment of the invention;

FIG. 3 is a block diagram illustrating the structure of a thermal management system for a fuel cell according to a second embodiment of the invention;

FIG. 4 is a block diagram illustrating the structure of a thermal management system for a fuel cell according to a third embodiment of the invention;

FIG. 5 is a block diagram illustrating the structure of a thermal management system for a fuel cell according to a fourth embodiment of the invention;

FIG. 6 is a block diagram illustrating the structure of a thermal management system for a fuel cell according to a fifth embodiment of the invention;

FIG. 7 is a block diagram illustrating the structure of a thermal management system for a fuel cell according to a sixth embodiment of the invention.

### DETAILED DESCRIPTION OF THE EMBODIMENTS

The invention is described below in detail with reference to accompanying drawings when read in conjunction with embodiments.

As shown in FIG. 1, the thermal management system for a fuel cell disclosed herein comprises: a cooling system 100 for recovering the waste heat produced by a fuel cell system, a heat supply system 15 connected with the cooling system to supply heat with the waste heat recovered by the cooling system 100. The cooling system 100 reduces the temperature of each component of the fuel cell system by cooling the component and recovers the waste heat generated by the fuel cell system, and the heat supply system 15 supplies heat by using the waste heat recovered by the cooling system as a heat source, thus effectively using the heat generated by a fuel cell stack, the heat of exhaust gas and the heat generated by electrical accessories during the running process of the fuel cell stack and consequentially reducing the running cost of the fuel cell.

The heat supply system 15 comprises: a waste heat supply system 13 and an electric heating heat supply system 14. The waste heat supply system 13 supplies heat with the waste heat recovered by the cooling system, the electric heating system 14 electrically supplies heat; when the heat supplied by the waste heat supply system 13 cannot meet the requirement of the user on the supply of heat, the electric heating system 14 supplies heat to compensate for the insufficiency of the waste heat supply system 13 in heat supply capacity. Preferably, the electric heating system 14 is connected with the waste heat supply system 13 in parallel so that the electric heating system 14 and the waste heat supply system 13 can work together to supply heat for the user when the heat supplied by the waste heat supply system 13 cannot meet the requirement of the user on the supply of heat.

The waste heat supply system 13 comprises: a cooling liquid heat supply system and an exhaust gas heat supply system. The cooling liquid heat supply system is provided at the downstream of the cooling system along the flow direction of a cooling medium to supply heat by using the waste heat of the fuel cell system recovered by the cooling medium of the cooling system as a heat source. The cooling liquid heat supply system comprises a plurality of cooling liquid heaters which are provided at the downstream of the cooling system along the flow direction of the cooling medium, wherein the cooling liquid heaters are main heat exchangers in which the heat of a high-temperature cooling medium is exchanged for heat supply. Preferably, the cooling liquid heat supply system further comprises fans which are provided corresponding to the cooling liquid heaters, wherein each cooling liquid heater is correspondingly provided with one or more fans, when the fans are working, the heat exchange efficiency of the heaters is increased to improve the effect of the heat supply.

There are a plurality of cooling liquid heaters which are connected with each other in series or in parallel or in series and in parallel and provided at the downstream of the cooling system along the flow direction of the cooling medium. When connected in series, the cooling liquid heaters exchange heat with the outside by level, the first level of cooling liquid heater which is significantly different in temperature from the outside has a high heat exchange efficiency, and as the level of a cooling liquid heater increases, the temperature difference between the cooling liquid heater and the outside as well as the heat exchange efficiency of the cooling liquid heater is reduced. When connected in parallel, the cooling liquid heaters all contain a high-temperature cooling medium, the temperature difference between the cooling liquid heaters and the outside is large and the heat exchange effect of the whole system is better, thus, it is preferred that the plurality of cooling liquid heaters are connected in parallel at the outlet end of the cooling system.

The exhaust gas heat supply system is connected with the exhaust gas outlet of the fuel cell stack, and a controllable switch is provided on the pipeline between the exhaust gas heat supply system and the exhaust gas outlet, wherein when the exhaust gas heat supply system is not needed to supply heat, the switch is turned off so that the exhaust gas emitted from the fuel cell stack is emitted into the atmosphere.

The fuel cell system mainly comprises the fuel cell stack and corresponding electrical devices which mainly comprise the power supply management system, a liquid pump for conveying the cooling medium and a gas pump for conveying fuels and oxidants for the fuel cell stack, and preferably, the gas pump is a compressor or a blower. Although the fuel cell stack is the major heat generation component when the fuel cell system is working, the power supply management system, the gas pump and the liquid pump also generate heat when in operation, thus, the temperature of the power supply management system, the gas pump and the liquid pump will be too high if the power supply management system, the gas pump and the liquid pump are not cooled timely. For this sake, the cooling system of the thermal management system for a fuel cell mainly comprises a cooling medium container 1 and a fuel cell stack cooling system 12 and an electrical device cooling system which are interconnected with the cooling medium container 1 through pipelines, wherein the electrical device cooling system comprises a pump cooling system 4 and a power supply management system cooling system 11 which is provided on the upstream or downstream of the fuel cell stack cooling system 12 along the flow direction of the cooling medium.

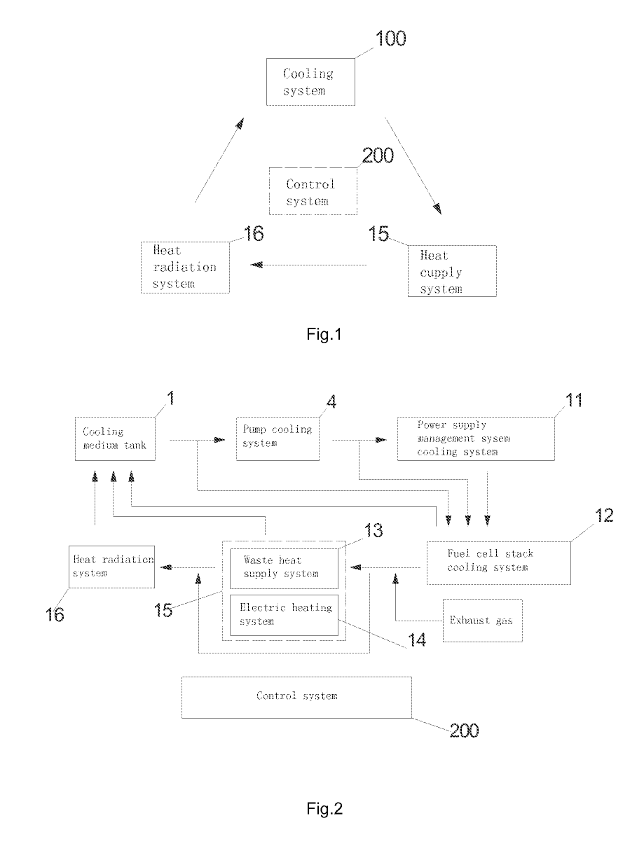

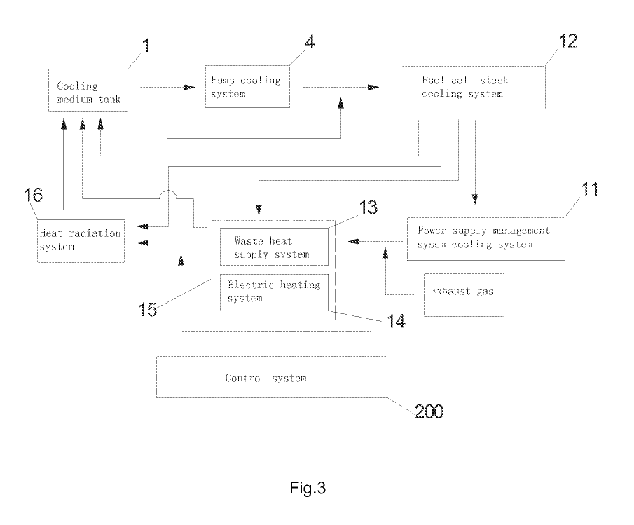

When the cooling medium gradually flows from a low-temperature component to a high-temperature component, as shown in FIG. 2, the amount of the cooling medium used can be effectively reduced while the heat exchange efficiency is increased, based on the principle, the amount of the heat generated by the power supply management system is small when the normal working power of the fuel cell system is low, in this case, the power supply management system cooling system 11 is provided at the upstream of the fuel cell stack cooling system 12 along the flow direction of the cooling medium. As shown in FIG. 3, the amount of the heat generated by the power supply management system is large when the normal working power of the fuel cell system is high, in this case, the power supply management system cooling system 11 is provided at the downstream of the fuel cell stack cooling system 12 along the flow direction of the cooling medium.

When the amount of the heat generated by the power supply management system is small, a power supply management system cooling system 11 located outside of the power supply management system is capable of meeting a cooling requirement, thus, the power supply management system cooling system 11 is provided as an external cooling system, the cooling pipeline of which is provided outside of the power supply management system and attached to the power supply management system, thereby meeting the cooling requirement with a simple structure at a low cost. When the amount of the heat generated by the power supply management system is large, a cooling pipeline outside of the power supply management system cannot meet the cooling requirement. In this case, the power supply management system cooling system 11 is provided as an internal cooling system the cooling pipeline of which is located inside the power supply management system, or a cooling medium path is provided inside the power supply management system so that the cooling medium can be directly contacted with the power supply management system to exchange heat adequately with the power supply management system to bring away the lots of heat generated by the power supply management system timely.

The thermal management system for a fuel cell further comprises: a heat radiation system 16 which comprises a plurality of radiators that are connected with each other in series or in parallel or in series and in parallel and provided at the downstream of the heat supply system along the flow direction of the cooling medium. When the radiators are connected in series, the cooling liquid heaters exchange heat with the outside by level, thus, a cooling medium of a lower temperature is obtained as the level of the cooling liquid heater increases, thereby achieving a better heat radiation effect to meet the requirement of the thermal management system for a fuel cell on heat radiation. Therefore, it is prepared that the plurality of radiators are provided in series. More preferably, the heat radiation system further comprises cooling fans which assist in heat radiation when the plurality of radiators cannot meet the requirement on heat radiation (that is, the temperature at the outlet end of the heat radiation system is outside a proper temperature range) of the system in the natural state to increase the heat exchange efficiency of the radiators so that the requirement of the system on heat radiation can be met, wherein each radiator can be correspondingly provided with one or more cooling fans. The outlet end of the heat radiation system is connected with the cooling medium container 1 of the cooling system to constitute a cooling medium circulating path.

The thermal management system for a fuel cell further comprises a control system 200 which comprises a cooling system control system, wherein the cooling system control system comprises a cooling medium container temperature control system for starting a heater to heat the cooling medium in the cooling medium container when the temperature of the cooling medium is lower than a first preset value. The first preset value is the optimal minimal temperature value of the cooling medium when the fuel cell is started, and the heater needs to be started to preheat the cooling medium to a proper starting temperature when the cooling medium is lower than the minimal temperature. A pump temperature control system is used to start the pump cooling system when the temperature of the liquid pump and the temperature of the gas pump are higher than a second preset value to reduce the temperature of the liquid pump and the temperature of the gas pump; the liquid pump and the gas pump generate little heat when the working power of the fuel cell is low, in this case, a heat radiation requirement can be met naturally or without dissipating the heat of the liquid pump and the gas pump, however, when the working power of the fuel cell exceeds a certain value, the heat generated by the liquid pump and the gas pump will make the liquid pump and the gas pump overheated. The second preset value is the optimal maximum temperature value of the liquid pump and the gas pump in operation, and when the temperature of the liquid pump and the gas pump is higher than the second preset value, a corresponding pump cooling system is started to make the liquid pump and the gas pump work within an optimal temperature range.

A power supply management system temperature control system for starting a power supply management system cooling system to reduce the temperature of the power supply management system when the temperature of the power supply management system is higher than a third preset value. Like the liquid pump and the gas pump, the temperature of the power supply management system is lowered by the power supply management system cooling system which is started by the power supply management system temperature control system when the temperature of the power supply management system is increased by the heat generated by the power supply management system to be higher than the maximum value (that is, the third preset value) in the optimal working temperature range of the power supply management system.

As the temperature of the fuel cell stack is controlled by the flow of the cooling medium, when the fuel cell stack in a high working power state generates a great amount of heat, a pump flow control system increases the flow of the cooling medium to enable the fuel cell stack to work in an optimal temperature range, similarly, when the fuel cell stack in a low working power state generates a small amount of heat, the pump flow control system decreases the flow of the cooling medium to enable the fuel cell stack to work in the optimal temperature range. When the temperature of the fuel cell stack is higher than a fourth preset value which is the maximum value in the optimal working temperature range of the fuel cell stack, the flow of the cooling medium is increased to reduce the temperature of the fuel cell stack so that the fuel cell stack works within the optimal temperature range.

The control system further comprises a heat supply system control system for starting the heat supply system to supply heat when indoor temperature is lower than a preset heating temperature. The heat supply system control system comprises: a cooling liquid heat supply system control system for starting, one by one, the cooling liquid heaters of the cooling liquid heat supply system to supply heat when indoor temperature is lower than the preset heating temperature and for starting fans corresponding to the cooling liquid heaters; an exhaust gas heat supply system control system for starting the exhaust gas heat supply system to supply heat together with the cooling liquid heat supply system when the maximum heating temperature of the cooling liquid heat supply system is lower than the preset heating temperature; and an electric heating heat supply system control system for starting the electric heating system 14 to supply heat together with the exhaust gas heat supply system and the cooling liquid heat supply system when the maximum heating temperature offered by the exhaust gas heat supply system and the cooling liquid heat supply system working together is lower than the preset heating temperature. When the supply of heat is needed, the heat supply by the cooling liquid is the first choice, that is, the cooling liquid heaters are started one by one. If the heat supply by the cooling liquid cannot meet the demand for heat supply, the heat supply by exhaust gas is started. The electric heating system 14 is only started when the demand for heat supply cannot be met by the cooling liquid heat supply system and the exhaust gas heat supply system working together.

The electric heating system 14 may be an air-conditioning which is controlled by a heat supply system controlling system to supply heat when the demand for heat supply cannot be met by the cooling liquid heat supply system and the exhaust gas heat supply system working together. The electric heating system 14, which may be an electric heater for heating the cooling liquid, may be provided inside the cooling liquid heat supply system to heat the cooling liquid in the cooling liquid heater when the demand for heat supply cannot be met by the cooling liquid heat supply system and the exhaust gas heat supply system working together so as to increase the temperature difference between the cooling liquid and ambient temperature to improve the heat supply capacity. The electric heater may be provided in a branch connected with the cooling liquid heater in parallel or series, and when the electric heating system 14 is needed to start, the gate of the branch is opened and the cooling liquid flows into the branch in which the cooling liquid is heated.

The control system further comprises a heat radiation system control system for starting the heat radiation system to reduce the temperature of the cooling medium when the temperature of the cooling medium inside the pipeline between the heat radiation system and the heat supply system is higher than a fifth preset value which is the maximum value in an optimal temperature range for the flow of the cooling medium back into the cooling medium container.

The invention also provides a fuel cell system which comprises a fuel cell stack and the aforementioned thermal management system for a fuel cell. The thermal management system for a fuel cell cools a fuel cell system by dissipating the heat of the fuel cell system and comprehensively uses the waste heat generated by the system.

As shown in FIG. 2, according to a first embodiment of the invention, a power supply management system cooling system 11 is provided at the upstream of a fuel cell stack cooling system 12 along the flow direction of a cooling medium which flows out from a cooling medium container 1, and a control system 200 determines whether or not it is needed to cool a pump and a power supply management system according to the output power of a fuel cell stack or by monitoring the temperature of the fuel cell stack.

When the output power of the fuel cell stack is small (e.g. when a car is running at a low speed or parked), the amount of the heat generated by electrical devices comprising a pump and a power supply management system is small, in this case, the cooling medium directly enters the fuel cell stack cooling system 12, contrarily, when the output power of the fuel cell stack is large, the amount of the heat generated by the electrical devices comprising the pump and the power supply management system is large, then the heat needs to be removed timely to guarantee the normal efficient operation of the electrical devices, in this case, the cooling medium flows into the fuel cell stack cooling system 12 after the pump and the power supply management system are cooled by a pump cooling system 4 and the power supply management system cooling system 11.

When the user has no need for the supply of heat, the cooling medium flows into a heat radiation system 16 or directly flows back into the cooling medium container 1, depending on the temperature of the cooling medium, and when the user needs the supply of heat, the cooling medium flows into a waste heat supply system 13 from the fuel cell stack cooling system 12. The exhaust gas of the system enters the waste heat supply system 13 when the heat offered by the cooling medium cannot meet the need of the user for the supply of heat, if the waste heat supply system 13 working at full capacity still cannot meet the need of the user for the supply of heat, an electric heating heat supply system 14 is started to compensate for the insufficiency of the waste heat supply system 13 in heat supply capacity. The cooling medium flowing out of a heat supply system 15 enters a heat radiation system 16 or directly flows back into the cooling medium container 1, depending on the temperature of the cooling medium.

As shown in FIG. 3, according to a second embodiment of the invention, a power supply management system cooling system 11 is provided at the downstream of a fuel cell stack cooling system 12 along the flow direction of a cooling medium which flows out from a cooling medium container 1, and a control system 200 determines whether or not it is needed to cool a liquid pump according to the output power of the fuel cell stack, the amount of the heat generated by the liquid pump is small when the output power of the fuel cell stack is small, the cooling medium directly flows into the fuel cell stack cooling system 12, contrarily, the amount of the heat generated by the liquid pump is large when the output power of the fuel cell stack is large, the cooling medium flows into the fuel cell stack cooling system 12 through the pump cooling system 4.

When the amount of the heat generated by the power supply management system is large as the output power of the fuel cell stack is large, It is needed to cool the power supply management system, and it is not needed to cool the power supply management system in other cases. The user can determine whether or not to start a heat supply system according to his own need, if the user needs the supply of heat, the cooling medium flows into the waste heat supply system 13; if the heat supplied by the cooling medium cannot meet the requirement of the user on the supply of heat, exhaust gas containing a great amount of waste heat flows into the waste heat supply system 13 to supply heat; if the requirement of the user on the supply of heat cannot be met by the waste heat supply system 13 working at full capacity, the electric heating system 14 is started to compensate for the insufficiency of the waste heat supply system in heat supply capacity. The cooling medium flowing out of the heat supply system flows into a heat radiation system 16 or directly flows back into the cooling medium container 1, depending on the temperature of the cooling medium; and when the user has no need for the supply of heat, the cooling medium flows into the heat radiation system 16 or directly flows back into the cooling medium container 1.

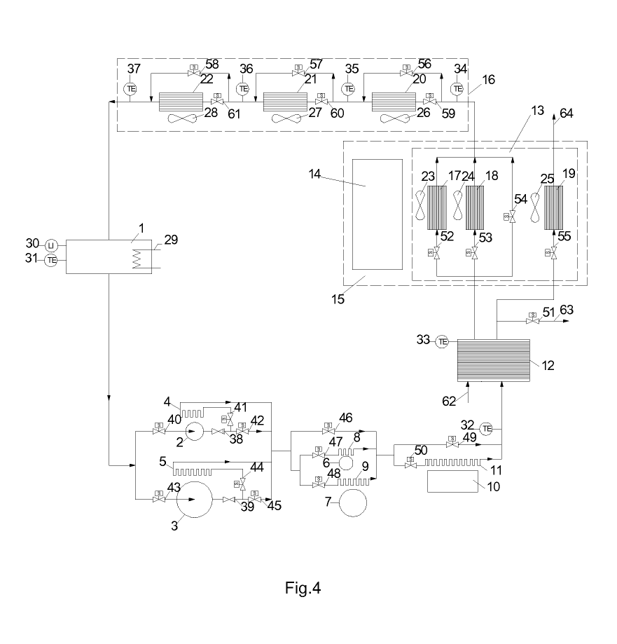

As shown in FIG. 4, according to embodiments described herein, a thermal management system for the fuel cell of a car specifically comprises a cooling liquid tank 1, a plurality of liquid pumps, pump cooling systems, a gas pump cooling system, a power supply management system 10, a power supply management system cooling system 11, a fuel cell stack and a fuel cell stack cooling system 12, a control system, a plurality of heat suppliers, radiators, cooling fans, solenoid valves, one-way valves, a temperature measurement device, a liquid level control device, a heater and pipelines. The power of a car is 60 kW, and the amount of the heat generated by the fuel cell in service is about 60 kW while the amount of the heat generated by electrical devices comprising the power supply management system, the pumps and the cooling fans accounts for about 10%, that is, 6 kW. In the integrated thermal management system of the car, a cooling liquid flows out of the cooling liquid tank 1, orderly flows through liquid pumps 2 and 3, liquid pump cooling systems 4 and 5, reactant gas pump cooling systems 8 and 9, the power supply management system cooling system 11, the fuel cell stack cooling system 12, a heat supply system 15 and a heat radiation system 16 and then returns into the cooling liquid tank 1. The power supply management system cooling system 11 is provided at the upstream of the fuel cell stack cooling system 12 along the flow direction of the cooling liquid. A heater 29, a liquid level controller 30 and a temperature sensor 31 are provided in the cooling liquid tank 1. When temperature is low, a car needs to be preheated before started, in this case, the heater 29 is started to heat the cooling liquid, the temperature sensor 31 detects the temperature of the cooling liquid in the cooling liquid tank 1, and electrical devices comprising the pumps 2 and 3 and the power supply management system 10 are started when the cooling liquid is heated to a proper starting temperature. The running condition of the pumps depends upon the thermal load of the system: when the system is just started, the thermal load of the system is small, the low-power pump 2 is started, and when the system runs normally, the thermal load of the system is large, the high-power pump 3 is started or the pumps 2 and 3 are started together. To prevent the backflow of the cooling liquid, one-way valves 38 and 39 are provided at outlets of the liquid pumps 2 and 3. Sequentially, the cooling liquid enters the power supply management system cooling system 11, as the power supply management system 10 generates a small amount of heat, to reduce the complicacy of the system, the heat generated by the power supply management system 10 is removed in an external cooling manner, in this case, the temperature of the cooling liquid is slightly higher than that of the cooling liquid in the cooling liquid tank 1. Then, the cooling liquid enters the fuel cell stack cooling system 12 to remove the great amount of waste heat generated by the fuel cell stack during the running process of the fuel cell stack, as a consequence, the temperature of the cooling liquid rises rapidly. The cooling liquid flowing out of the fuel cell stack cooling system 12 flows through or bypasses the waste heat supply system 13, depending on the need of the user.

When the user has a need for the supply of heat, the solenoid valve 54 is closed so that the cooling liquid enters the cooling liquid heat supply system, the control system 200 selectively starts one or more cooling liquid heaters 17 and 18 and corresponding fans 23 and 24 according to the need of the user for the supply of heat. If the need of the user for the supply of heat cannot be met even when the cooling liquid heat supply system works at full capacity (all the cooling liquid heaters and corresponding fans are started), the solenoid valve 51 is closed while the solenoid valve 55 is opened so that exhaust gas enters the exhaust gas heater 19 through a pipeline. If the need of the user for the supply of heat cannot be met even when the whole waste heat supply system 13 works at full capacity (the exhaust gas heat supply system and the cooling liquid heat supply system both work at full capacity), the electric heating system 14 is started to supply heat together with the waste heat supply system 13 to compensate for the insufficiency of the exhaust gas heat supply system 13 in heat supply capacity.

The cooling liquid flowing out of the heat supply system 15 flows into the heat radiation system 16, the temperature at the temperature measurement point 34 between the heat supply system 15 and the heat radiation system 16 is detected first, if the temperature of the cooling liquid meets a circulation requirement, the solenoid valves 56, 57 and 58 are opened while the solenoid valves 59, 60 and 61 are closed so that the cooling liquid directly flows back into the cooling liquid tank 1 from the heat supply system 15 without passing through a radiator, if the temperature at the temperature measurement point 34 is higher than the maximum value in an optimal temperature range, the solenoid valve 59 is opened while the solenoid valve 56 is closed so that the cooling liquid is cooled by the radiator 20. In consideration of environment protection, the cooling fan 26 is not started in the first place; if the temperature fed back from the temperature monitoring point 35 at the outlet end of the radiator 20 is within the optimal temperature range, the solenoid valves 57 and 58 are opened while the solenoid valves 60 and 61 are closed so that the cooling liquid flows through the radiator 20 and then flows back into the cooling liquid tank 1. If the temperature fed back from the temperature monitoring point 35 is higher than the maximum value in the optimal temperature range, the cooling fan 26 is started, then the temperature of the monitoring point 35 is detected again, if the temperature is within the optimal temperature range, the cooling liquid flows through the radiator 20 and then flows back into the cooling liquid tank 1; if the temperature is still beyond the optimal temperature range, the solenoid valve 60 is opened while the solenoid valve 57 is closed so that the cooling liquid flows into the radiator 21. Whether or not to start the cooling fan 27 is determined according to the temperature fed back from the monitoring point 36. If the temperature of the monitoring point 36 is still beyond the optimal temperature range after the cooling fan 27 is started, the solenoid valve 61 is opened while the solenoid valve 58 is closed so that the cooling liquid flows into the radiator 22. Similarly, whether or not to start the cooling fan 28 is determined according to the temperature of the monitoring point 37. The cooling liquid cooled to a proper temperature range is conveyed back into the cooling liquid tank 1 through a pipeline.

Preferably, to reduce energy consumption and usage cost, the heat radiation system 16 may be controlled in the following way: the cooling liquid flowing out of the heat supply system 15 flows into the heat radiation system 16, the temperature at the temperature measurement point 34 between the heat supply system 15 and the heat radiation system 16 is detected first, if the temperature of the cooling liquid meets a circulation requirement, the solenoid valves 56, 57 and 58 are opened while the solenoid valves 59, 60 and 61 are closed so that the cooling liquid directly flows back into the cooling liquid tank 1 from the heat supply system 15 without passing through a radiator, if the temperature at the temperature measurement point 34 is higher than the maximum value in an optimal temperature range, the solenoid valve 59 is opened while the solenoid valve 56 is closed so that the cooling liquid is cooled by the radiator 20; the cooling fan 26 is not started in the first place, if the temperature fed back from the temperature monitoring point 35 at the outlet end of the radiator 20 is within the optimal temperature range, the solenoid valves 57 and 58 are opened while the solenoid valves 60 and 61 are closed so that the cooling liquid flows through the radiator 20 and then flows back into the cooling liquid tank 1. If the temperature fed back from the temperature monitoring point 35 is higher than the maximum value in the optimal temperature range, the solenoid valve 60 is opened while solenoid valve 57 is closed so that the cooling liquid flows into the radiator 21, if the temperature fed back from the temperature monitoring point 36 at the outlet end of the radiator 21 is higher than the maximum value in the optimal temperature range, the solenoid valve 61 is opened while the solenoid valve 58 is closed so that the cooling liquid flows into the radiator 22, if the temperature fed back from the temperature monitoring point 37 at the outlet end of the radiator 22 is higher than the maximum value in the optimal temperature range, a cooling fan is started, and if the started cooling fan cannot meet a heat radiation requirement, the other cooling fans are started one by one. That is, the cooling medium is first naturally cooled by the plurality of radiators to an optional temperature range, and if the natural heat radiation by the plurality of radiators cannot meet the requirement, the cooling fans are started to assist in heat radiation.

The invention also provides a car comprising wheels, a car body, a transmission system and a fuel cell system using the aforementioned thermal management system for the fuel cell of a car. The terminal management system for the fuel cell of a car comprises a power supply management system cooling system and a fuel cell stack cooling system, wherein the power supply management system cooling system is an external cooling system provided at the upstream of the fuel cell stack cooling system along the flow direction of a cooling medium, and the heat supply system of the thermal management system for the fuel cell of a car supplies heat for the inside of the car body.

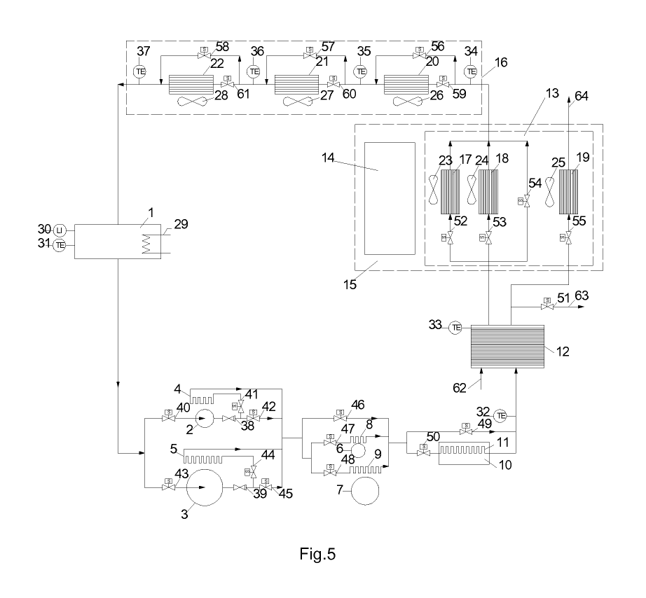

As shown in FIG. 5, according to embodiments described herein, a thermal management system for the fuel cell of a bus specifically comprises a cooling liquid tank 1, a plurality of cooling liquid transfer pumps, a pump cooling system, gas pump cooling systems, a power supply management system 10, a power supply management system cooling system 11, a fuel cell stack, a fuel call stack cooling system 12, a control system, a plurality of heat suppliers, radiators, cooling fans, solenoid valves, one-way valves, a temperature measurement device, a liquid level control device, a heater and pipelines. The power of the bus is 200 kW, and the amount of the heat generated by the fuel cell in service is about 200 kW while the amount of the heat generated by electrical devices comprising the power supply management system, the pumps, gas pumps and the cooling fans is about 20 kW. In the thermal management system for the fuel cell of a bus, a cooling liquid flows out of the cooling liquid tank 1, sequentially flows through pumps 2 and 3, pump cooling systems 4 and 5, reactant gas pump cooling systems 8 and 9, the power supply management system cooling system 11, the fuel cell stack cooling system 12, a heat supply system 15 and a heat radiation system 16 and then returns into the cooling liquid tank 1, and the power supply management system cooling system 11 is provided at the upstream of the fuel cell stack cooling system 12 along the flow direction of the cooling liquid. A heater 29, a liquid level controller 30 and a temperature sensor 31 are provided in the cooling liquid tank 1. When temperature is low, the bus needs to be preheated before started, in this case, the heater 29 is started to heat the cooling liquid, the temperature sensor 31 detects the temperature of the cooling liquid in the cooling liquid tank 1, and electrical devices comprising the pumps 2 and 3 and the power supply management system 10 are started when the cooling liquid is heated to a proper starting temperature. The running condition of the liquid pumps and the gas pumps depends upon the thermal load of the system, when the system is just started, the thermal load of the system is small, the small-power pump 2 and the small gas pump 6 are started, and as the amount of the heat generated by each motor is small, the pump cooling system 4 and the gas pump cooling system 8 are not started; when the system runs normally, the thermal load of the system is increased and the high-power pump 3 is started or the pumps 2 and 3 are started together, then the pump cooling systems 4 and 5 are started to cool the pumps 2 and 3, and the gas pump cooling systems 8 and 9 cool the gas pumps 6 and 7. One-way valves 33 and 34 are provided at outlets of the pumps 2 and 3 to prevent the backflow of the cooling liquid. Then, the cooling liquid enters the power supply management system cooling system 11, as the amount of the heat generated by the power supply management system 10 is large, to improve cooling effect, an internal cooling scheme is adopted, that is, a cooling pipeline is provided inside the power supply management system or a cooling medium path is provided inside the power supply management system, so that the cooling medium can be directly contacted with the power supply management system to exchange heat adequately with the power supply management system to bring away the abundant heat generated by the power supply management system 10 timely.

The cooling liquid flowing out of the power supply management system cooling system 11 flows into the fuel cell stack cooling system 12 to remove the abundant waste heat generated by the fuel cell stack during the running process of the fuel cell stack, as a consequence, the temperature of the cooling liquid rises rapidly. The cooling liquid flowing out of the fuel cell stack cooling system 12 flows through or bypasses the waste heat supply system 13, depending on the need of the user.

When the user has a need for the supply of heat, the solenoid valve 54 is closed so that the cooling liquid flows into the cooling liquid heat supply system, the control system 200 selectively starts one or more cooling liquid heaters 17 and 18 and corresponding fans 23 and 24 according to the need of the user for the supply of heat. If the need of the user for the supply of heat cannot be met even when the cooling liquid heat supply system works at full capacity (all the cooling liquid heaters and corresponding fans are started), the solenoid valve 51 is closed while the solenoid valve 55 is opened so that exhaust gas enters the exhaust gas heater 19 through a pipeline. If the need of the user for the supply of heat cannot be met even when the whole waste heat supply system 13 works at full capacity (the exhaust gas heat supply system and the cooling liquid heat supply system both work at full capacity), the electric heating system 14 is started to supply heat together with the waste heat supply system 13 to compensate for the insufficiency of the exhaust gas heat supply system 13 in heat supply capacity.

The cooling liquid flowing out of the heat supply system 15 flows into the heat radiation system 16, the temperature at the temperature measurement point 34 between the heat supply system 15 and the heat radiation system 16 is detected first, if the temperature of the cooling liquid meets a circulation requirement, the solenoid valves 56, 57 and 58 are opened while the solenoid valves 59, 60 and 61 are closed so that the cooling liquid directly flows back into the cooling liquid tank 1 from the heat supply system 15 without passing through a radiator, if the temperature at the temperature measurement point 34 is higher than the maximum value in an optimal temperature range, the solenoid valve 59 is opened while the solenoid valve 56 is closed so that the cooling liquid is cooled by the radiator 20. In consideration of environment protection, the cooling fan 26 is not started in the first place, if the temperature fed back from the temperature monitoring point 35 at the outlet end of the radiator 20 is within the optimal temperature range, the solenoid valves 57 and 58 are opened while the solenoid valves 60 and 61 are closed so that the cooling liquid flows through the radiator 20 and then flows back into the cooling liquid tank 1. If the temperature fed back from the temperature monitoring point 35 is higher than the maximum value in the optimal temperature range, the cooling fan 26 is started, then the temperature of the monitoring point 35 is detected again, if the temperature is within the optimal temperature range, the cooling liquid flows through the radiator 20 and then flows back into the cooling liquid tank 1, if the temperature is still beyond the optimal temperature range, the solenoid valve 60 is opened while the solenoid valve 57 is closed so that the cooling liquid flows into the radiator 21. Whether or not to start the cooling fan 27 is determined according to the temperature fed back from the monitoring point 36. If the temperature of the monitoring point 36 is still beyond the optimal temperature range after the cooling fan 27 is started, the solenoid valve 61 is opened while the solenoid valve 58 is closed so that the cooling liquid flows into the radiator 22. Similarly, whether or not to start the cooling fan 28 is determined according to the temperature of the monitoring point 37. The cooling liquid cooled to a proper temperature range is conveyed back into the cooling liquid tank 1 through a pipeline.

Preferably, to reduce energy consumption and usage cost, the heat radiation system 16 is controlled in the following way: the cooling liquid flowing out of the heat supply system 15 flows into the heat radiation system 16, the temperature at the temperature measurement point 34 between the heat supply system 15 and the heat radiation system 16 is detected first, if the temperature of the cooling liquid meets a circulation requirement, the solenoid valves 56, 57 and 58 are opened while the solenoid valves 59, 60 and 61 are closed so that the cooling liquid directly flows back into the cooling liquid tank 1 from the heat supply system 15 without passing through a radiator, if the temperature at the temperature measurement point 34 is higher than the maximum value in an optimal temperature range, the solenoid valve 59 is opened while the solenoid valve 56 is closed so that the cooling liquid is cooled by the radiator 20, the cooling fan 26 is not started in the first place, if the temperature fed back from the temperature monitoring point 35 at the outlet end of the radiator 20 is within the optimal temperature range, the solenoid valves 57 and 58 are opened while the solenoid valves 60 and 61 are closed so that the cooling liquid flows through the radiator 20 and then flows back into the cooling liquid tank 1. If the temperature fed back from the temperature monitoring point 35 is higher than the maximum value in the optimal temperature range, the solenoid valve 60 is opened while solenoid valve 57 is closed so that the cooling liquid flows into the radiator 21, if the temperature fed back from the temperature monitoring point 36 at the outlet end of the radiator 21 is higher than the maximum value in the optimal temperature range, the solenoid valve 61 is opened while the solenoid valve 58 is closed so that the cooling liquid flows into the radiator 22, and the temperature fed back from the temperature monitoring point 37 at the outlet end of the radiator 22 is higher than the maximum value in the optimal temperature range, a cooling fan is started, and if one cooling fan cannot meet the requirement on heat radiation, the other cooling fans are started one by one. That is, the cooling medium is first naturally cooled by the plurality of radiators to an optional temperature range, and if the natural heat radiation by the plurality of radiators cannot meet the requirement, the cooling fans are started to assist in heat radiation.

The invention also provides a bus comprising wheels, a body, a transmission system and a fuel cell system using the aforementioned thermal management system for the fuel cell of a bus. The terminal management system for the fuel cell of a bus comprises a power supply management system cooling system and a fuel cell stack cooling system, wherein the power supply management system cooling system is an internal or external cooling system provided at the upstream of the fuel cell stack cooling system along the flow direction of a cooling medium, and the heat supply system of the thermal management system for the fuel cell of a bus supplies heat for the inside of the body of the bus.

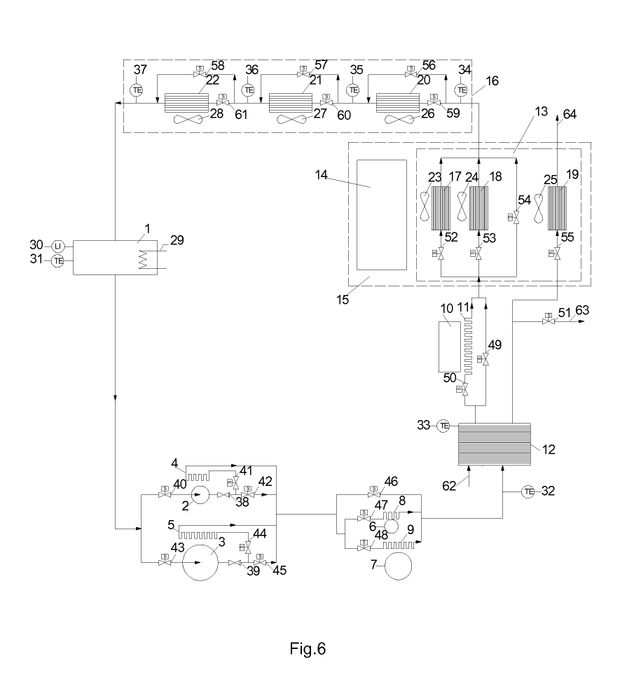

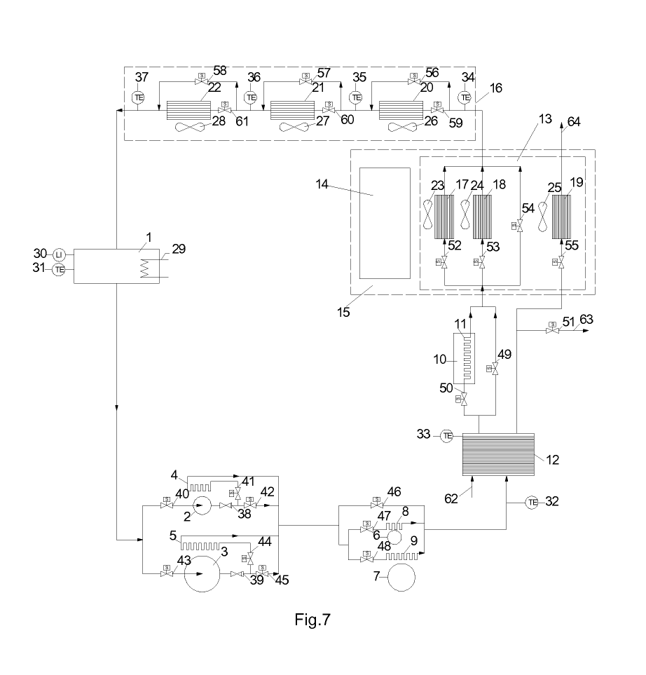

As shown in FIG. 6 and FIG. 7, according to embodiments described herein, a thermal management system for the fuel cell of a large locomotive specifically comprises a cooling liquid tank 1, a plurality of liquid pumps, a pump cooling system, gas pump cooling systems, a power supply management system 10, a power supply management system cooling system 11, a fuel cell stack, a fuel call stack cooling system 12, a control system 200, a plurality of heat suppliers, radiators, cooling fans, solenoid valves, one-way valves, a temperature measurement device, a liquid level control device, a heater and pipelines. The power of the large locomotive is about 1000 kW, and the amount of the heat generated by the fuel cell in service is about 1000 kW while the amount of the heat generated by electrical devices, comprising the power supply management system 10, the liquid pumps 2 and 3 and gas pumps 6 and 7, and the cooling fans 23 to 38, accounts for about 10%, that is, 100 kW. In the integrated thermal management system of the large locomotive, a cooling liquid flows out of the cooling liquid tank 1, sequentially flows through pumps 2 and 3, liquid pump cooling systems 4 and 5, reactant gas pump cooling systems 8 and 9, the fuel cell stack cooling system 12, the power supply management system cooling system 11, a waste heat supply system 13 and a heat radiation system 16 and then returns into the cooling liquid tank 1, and the power supply management system cooling system 11 is provided at the downstream of the fuel cell stack cooling system 12 along the flow direction of the cooling liquid. A heater 29, a liquid level controller 30 and a temperature sensor 31 are provided in the cooling liquid tank 1. When temperature is low, the large locomotive needs to be preheated before started, in this case, the heater 29 is started to heat the cooling liquid, the temperature sensor 31 detects the temperature of the cooling liquid in the cooling liquid tank 1, and electrical devices comprising the pumps 2 and 3 and the power supply management system 10 are started when the cooling liquid is heated to a proper starting temperature. The running condition of the liquid pumps and the gas pumps depends upon the thermal load of the system, when the locomotive is just started or runs at a low speed, the thermal load of the system is small, the small-power pump 2 is started while the pump cooling system 4 and the gas pump cooling system 8 are started, after the system runs normally, the thermal load of the system is increased, the high-power pump 3 is started or the pumps 2 and 3 are started together, then the pump cooling systems 4 and 5 are started to cool the pumps, and the gas pump cooling systems 8 and 9 cool the gas pumps 6 and 7, respectively. One-way valves 38 and 39 are provided at outlets of the pumps 2 and 3 to prevent the backflow of the cooling liquid. The cooling liquid flowing out of the gas pump cooling systems 8 and 9 flows into the fuel cell stack cooling system 12 to remove the abundant waste heat generated by the fuel cell stack during the running process of the fuel cell stack, as a consequence, the temperature of the cooling liquid rises rapidly. Then, the cooling liquid flows into the power supply management system cooling system 11. As the power supply management system 10 generates a great amount of heat, the power supply management system cooling system 11 is provided at the downstream of the fuel cell stack 12 along the flow direction of the cooling liquid for the sake of the heat resistance of each component. More preferably, as shown in FIG. 7, the heat generated by the power supply management system 10 is removed in an internal cooling manner.

The cooling liquid flowing out of the power supply management system cooling system 11 flows through or bypasses the heat supply system 15, depending on the need of the user. When the user has a need for the supply of heat, the solenoid valve 54 is closed so that the cooling liquid flows into the cooling liquid heat supply system, the control system 200 selectively starts one or more cooling liquid heaters 17 and 18 and corresponding fans 23 and 24 according to the need of the user for the supply of heat. If the need of the user for the supply of heat cannot be met even when the cooling liquid heat supply system works at full capacity (all the cooling liquid heaters and corresponding fans are started), the solenoid valve 51 is closed while the solenoid valve 55 is opened so that exhaust gas enters the exhaust gas heater 19 through a pipeline. If the need of the user for the supply of heat cannot be met even when the whole waste heat supply system 13 works at full capacity (the exhaust gas heat supply system and the cooling liquid heat supply system both work at full capacity), the electric heating system 14 is started to supply heat together with the waste heat supply system 13 to compensate for the insufficiency of the exhaust gas heat supply system 13 in heat supply capacity.

The cooling liquid flowing out of the heat supply system 15 flows into the heat radiation system 16, the temperature at the temperature measurement point 34 between the heat supply system 15 and the heat radiation system 16 is detected first, if the temperature of the cooling liquid meets a circulation requirement, the solenoid valves 56, 57 and 58 are opened while the solenoid valves 59, 60 and 61 are closed so that the cooling liquid directly flows back into the cooling liquid tank 1 from the heat supply system 15 without passing through a radiator, if the temperature at the temperature measurement point 34 is higher than the maximum value in an optimal temperature range, the solenoid valve 59 is opened while the solenoid valve 56 is closed so that the cooling liquid is cooled by the radiator 20, in consideration of environment protection, the cooling fan 26 is not started in the first place, if the temperature fed back from the temperature monitoring point 35 at the outlet end of the radiator 20 is within the optimal temperature range, the solenoid valves 57 and 58 are opened while the solenoid valves 60 and 61 are closed so that the cooling liquid flows through the radiator 20 and then flows back into the cooling liquid tank 1. If the temperature fed back from the temperature monitoring point 35 is higher than the maximum value in the optimal temperature range, the cooling fan 26 is started, then the temperature of the monitoring point 35 is detected again, if the temperature is within the optimal temperature range, the cooling liquid flows through the radiator 20 and then flows back into the cooling liquid tank 1, if the temperature is still beyond the optimal temperature range, the solenoid valve 60 is opened while the solenoid valve 57 is closed so that the cooling liquid flows into the radiator 21. Whether or not to start the cooling fan 27 is determined according to the temperature fed back from the monitoring point 36. If the temperature of the monitoring point 36 is still beyond the optimal temperature range after the cooling fan 27 is started, the solenoid valve 61 is opened while the solenoid valve 58 is closed so that the cooling liquid flows into the radiator 22. Similarly, whether or not to start the cooling fan 28 is determined according to the temperature of the monitoring point 37. The cooling liquid cooled to a proper temperature range is conveyed back into the cooling liquid tank 1 through a pipeline.

Preferably, to reduce energy consumption and usage cost, the heat radiation system 16 is controlled in the following way: the cooling liquid flowing out of the heat supply system 15 flows into the heat radiation system 16, the temperature at the temperature measurement point 34 between the heat supply system 15 and the heat radiation system 16 is detected first, if the temperature of the cooling liquid meets a circulation requirement, the solenoid valves 56, 57 and 58 are opened while the solenoid valves 59, 60 and 61 are closed so that the cooling liquid directly flows back into the cooling liquid tank 1 from the heat supply system 15 without passing through a radiator, if the temperature at the temperature measurement point 34 is higher than the maximum value in an optimal temperature range, the solenoid valve 59 is opened while the solenoid valve 56 is closed so that the cooling liquid is cooled by the radiator 20, the cooling fan 26 is not started in the first place, if the temperature fed back from the temperature monitoring point 35 at the outlet end of the radiator 20 is within the optimal temperature range, the solenoid valves 57 and 58 are opened while the solenoid valves 60 and 61 are closed so that the cooling liquid flows through the radiator 20 and then flows back into the cooling liquid tank 1. If the temperature fed back from the temperature monitoring point 35 is higher than the maximum value in the optimal temperature range, the solenoid valve 60 is opened while solenoid valve 57 is closed so that the cooling liquid flows into the radiator 21, if the temperature fed back from the temperature monitoring point 36 at the outlet end of the radiator 21 is higher than the maximum value in the optimal temperature range, the solenoid valve 61 is opened while the solenoid valve 58 is closed so that the cooling liquid flows into the radiator 22, if the temperature fed back from the temperature monitoring point 37 at the outlet end of the radiator 22 is higher than the maximum value in the optimal temperature range, a cooling fan is started, and if one cooling fan cannot meet the requirement on heat radiation, then other cooling fans are started one by one. That is, the cooling medium is first naturally cooled by the plurality of radiators to an optional temperature range, and if the natural heat radiation by the plurality of radiators cannot meet the requirement, the cooling fans are started to assist in heat radiation.

The invention also provides a large locomotive comprising wheels, a locomotive body, a transmission system and a fuel cell system using the aforementioned thermal management system for the fuel cell of a large locomotive, wherein the terminal management system for the fuel cell of a large locomotive comprises a power supply management system cooling system and a fuel cell stack cooling system, wherein the power supply management system cooling system is an external or internal cooling system provided at the downstream of the fuel cell stack cooling system along the flow direction of a cooling medium, and the heat supply system of the thermal management system for the fuel cell of a large locomotive supplies heat for the inside of the body of the large locomotive.

It can be seen from the description above that the embodiments described herein achieve the following technical effects:

according to the thermal management system for a fuel cell, the fuel cell system and the vehicle equipped with the fuel cell system disclosed herein, the thermal management system for a fuel cell reduces the temperature of each component of the fuel cell system by cooling the component using a cooling system and recovers the waste heat generated by the fuel cell system, and a heat supply system supplies heat by using the waste heat recovered by the cooling system as a heat source, thus effectively using the heat generated by a fuel cell stack, the heat of exhaust gas and the heat generated by electrical accessories during the running process of the fuel cell stack and consequentially reducing the running cost of the fuel cell.

The mentioned above is only preferred embodiments of the invention but not limitation to the invention, it should be appreciated that various modification and variations can be devised by those of ordinary skill in the art. Any modification, equivalent or improvement devised without departing from the spirit and scope of the invention should fall within the protection range of the invention.

1. A thermal management system for a fuel cell, comprising:
a cooling system configured to recover the waste heat generated by a fuel cell system; and
a heat supply system connected with the cooling system to supply heat using the waste heat recovered by the cooling system.

2. The thermal management system for a fuel cell according to claim 1, wherein the heat supply system comprises:
a waste heat supply system configured to supply heat using the waste heat recovered by the cooling system; and
an electric heating heat supply system configured to electrically supply heat.

3. The thermal management system for a fuel cell according to claim 2, wherein the waste heat supply system comprises:
a cooling liquid heat supply system provided at the downstream of the cooling system along the flow direction of a cooling medium; and
an exhaust gas heat supply system connected with the exhaust gas outlet of a fuel cell stack.

4. The thermal management system for a fuel cell according to claim 3, wherein the cooling liquid heat supply system comprises:
cooling liquid heaters provided at the downstream of the cooling system along the flow direction of the cooling medium; and
fans provided corresponding to the cooling liquid heaters.

5. The thermal management system for a fuel cell according to claim 4, wherein
there are a plurality of cooling liquid heaters which are connected with each other in series or in parallel or in series and in parallel and provided at the downstream of the cooling system along the flow direction of the cooling medium, and
one or more fans are correspondingly provided for each cooling liquid heater.

6. The thermal management system for a fuel cell according to claim 2, wherein the electric heating system is connected with the waste heat supply system in parallel.

7. The thermal management system for a fuel cell according to claim 1, wherein
the cooling system comprises a fuel cell stack cooling system and an electrical device cooling system which are interconnected with each other through a pipeline;
wherein the electrical device cooling system comprises a pump cooling system and a power supply management system cooling system;
and the power supply management system cooling system is provided at the upstream or downstream of the fuel cell stack cooling system along the flow direction of the cooling medium.

8. The thermal management system for a fuel cell according to claim 7, wherein the power supply management system cooling system is an external cooling system or an internal cooling system;
the cooling pipeline of the external cooling system is located outside of a power supply management system and attached to the power supply management system; and
the cooling pipeline of the internal cooling system is located inside the power supply management system.

9. The thermal management system for a fuel cell according to claim 1, further comprising: a heat radiation system which comprises:
a plurality of radiators which are connected with each other in series or in parallel or in series and in parallel and provided at the downstream of the heat supply system along the flow direction of the cooling medium; and
cooling fans, wherein one or more cooling fans are correspondingly provided for each radiator.

10. The thermal management system for a fuel cell according to claim 1, further comprising: a control system which comprises:
a cooling system control system, the cooling system control system comprising:
a cooling medium container temperature control system for starting a heater to heat the cooling medium when the temperature of the cooling medium is lower than a first preset value;
a pump temperature control system for starting a pump cooling system to reduce the temperature of a liquid pump and a gas pump when the temperature of the liquid pump and the temperature of the gas pump are higher than a second preset value;
a power supply management system temperature control system for starting a power supply management system cooling system to reduce the temperature of the power supply management system when the temperature of the power supply management system is higher than a third preset value; and
a pump flow control system for increasing the flow of the liquid pump to reduce the temperature of the fuel cell stack when the temperature of the fuel cell stack is higher than a fourth preset value.

11. The thermal management system for a fuel cell according to claim 10, wherein the control system also comprises a heat supply system control system for starting the heat supply system to supply heat when indoor temperature is lower than a preset heating temperature.

12. The thermal management system for a fuel cell according to claim 11, wherein the heat supply system control system comprises:
a cooling liquid heat supply system control system which controls the cooling liquid heaters of the cooling liquid heat supply system to start one by one to supply heat and starts fans corresponding to the cooling liquid heater when indoor temperature is lower than the preset heating temperature;
an exhaust gas heat supply system control system which controls the exhaust gas heat supply system to start to supply heat together with the cooling liquid heat supply system when the maximum heating temperature of the cooling liquid heat supply system is lower than the preset heating temperature;
and an electric heating heat supply system control system which controls the electric heating system to start to supply heat together with the exhaust gas heat supply system and the cooling liquid heat supply system when the maximum heating temperature offered by the exhaust gas heat supply system and the cooling liquid heat supply system working together is lower than the preset heating temperature.

13. The thermal management system for a fuel cell according to claim 10, wherein the control system further comprises a heat radiation system control system for starting the heat radiation system to cool the cooling medium when the temperature of the cooling medium inside the pipeline between the heat radiation system and the heat supply system is higher than a fifth preset value.

14. The thermal management system for a fuel cell according to claim 11, wherein the control system further comprises a heat radiation system control system for starting the heat radiation system to cool the cooling medium when the temperature of the cooling medium inside the pipeline between the heat radiation system and the heat supply system is higher than a fifth preset value.

15. A fuel cell system, comprising: a fuel cell stack; and the thermal management system for a fuel cell claimed in claim 1.

16. A vehicle, comprising, wheels, a vehicle body, a transmission system and the fuel cell system claimed in claim 15.

17. The vehicle according to claim 16, wherein the vehicle is a car;
the thermal management system for a fuel cell of the fuel cell system comprises a power supply management system cooling system and a fuel cell stack cooling system, wherein the power supply management system cooling system is provided at the upstream of the fuel cell stack cooling system along the flow direction of a cooling medium;
the power supply management system cooling system is an external cooling system; and
the heat supply system of the thermal management system for a fuel cell supplies heat to the inside of the body of the car.

18. The vehicle according to claim 16, wherein the vehicle is a bus;
the thermal management system for a fuel cell of the fuel cell system comprises a power supply management system cooling system and a fuel cell stack cooling system, wherein the power supply management system cooling system is provided at the upstream of the fuel cell stack cooling system along the flow direction of the cooling medium;
the power supply management system cooling system is an internal or external cooling system; and
the heat supply system of the thermal management system for a fuel cell supplies heat to the inside of the body of the bus.

19. The vehicle according to claim 16, wherein the vehicle is a large locomotive;
the thermal management system for a fuel cell of the fuel cell system comprises a power supply management system cooling system and a fuel cell stack cooling system, wherein the power supply management system cooling system is provided at the upstream or the downstream of the fuel cell stack cooling system along the flow direction of a cooling medium;
the power supply management system cooling system is an internal or external cooling system; and
the heat supply system of the thermal management system for a fuel cell supplies heat to the inside of the body of the large locomotive.
